(19) United States
(12) Patent Application Publication
(10) Pub. No.: US 2013/0285414 A1
(43) Pub. Date: Oct. 31, 2013

(54) AUTOMATIC VEHICLE STIFFENED PILLAR ASSEMBLY

(71) Applicants: Bhimaraddi Venkaraddi Alavandi, Canton, MI (US); Naeem Ahmed Ghias, Canton, MI (US); Wanjun Lei, Ann Arbor, MI (US)

(72) Inventors: Bhimaraddi Venkaraddi Alavandi, Canton, MI (US); Naeem Ahmed Ghias, Canton, MI (US); Wanjun Lei, Ann Arbor, MI (US)

(73) Assignee: FORD GLOBAL TECHNOLOGIES, LLC, DEARBORN, MI (US)

(21) Appl. No.: 13/455,139

(22) Filed: Apr. 25, 2012

(51) Int. Cl. B62D 25/04

(52) U.S. Cl. 296/193.06

(57) ABSTRACT

A hinge pillar assembly employed for attaching a front door to an automotive vehicle is disclosed. The hinge pillar assembly includes a first pillar and a second pillar. The first pillar has cavities, which are capable of receiving bulkheads. The bulkheads are adapted based on dimensions of the cavities in order to substantially secure the bulkheads in the cavities. The second pillar is mounted over the first pillar to enclose the bulkheads.

### BACKGROUND

This application generally relates to reinforcement members for automotive vehicles, and, more particularly, relates to stiffening of a hinge pillar assembly in automotive vehicles.

In recent years, occupant safety in automotive vehicles has changed the consumer perspective towards selection of automotive vehicles. Various automotive safety techniques, for example, those pertaining to air bags, seat belts and head restraints, are implemented in automotive vehicles based on a variety of safety standards related to crash avoidance, crashworthiness and post crash capability of the vehicle. Crashworthiness of a vehicle defines the safety capability of a vehicle during an impact from different types of crashes, such as frontal crashes, side crashes, and rollover crashes. The frontal crashes with partial, narrow or small overlap impact (SOI) are common and found to be most hazardous for occupant safety in various crash tests conducted by National Highway Traffic Safety Administration (NHTSA) and Insurance Institute for Highway Safety (IIHS). A vehicle is provided with frontal structures, for example, bonnet, crush horn, etc., which provide stiffness to the vehicle body and reduce intrusion of the crash load in the occupant compartment. Although such structures are effective in full frontal crashes, they are not a reliable safety solution in the case of SOI crashes due to their limited or no engagement with the crash load.

A frontal crash is termed as small overlap impact (SOI) crash when there is an overlap of less than thirty percent of width of a vehicle with a collision entity, such as a car, a lamppost or a wall. Primarily, SOI crashes hinder occupant safety through introduction of oblique kinematics in the vehicle body, and deformation of the occupant compartment due to crash load. The oblique kinematics of the vehicle body causes the lower extremity of the occupant to move laterally with respect to air bags. As a result, the occupant may suffer a head impact from outboard components, such as the door and A-pillar, or inboard components, for example, the instrument panel, steering wheel, etc. or an object external to the vehicle. In addition, deformation of the occupant compartment can result in rotation of the steering column, thereby causing the head of an occupant to move away from the coverage area of air bags. Further, such deformation of the compartment can lead to intrusion of the outboard components and can put the occupant in danger.

A common approach to improve crashworthiness of a vehicle towards SOI crashes is to increase thickness of the A-pillar and the hinge pillar assemblies to maintain vehicle body integrity after crash impact loading. However, such an increase in thickness of the pillar assemblies can significantly increase the vehicle weight, which degrades the desired efficiency and performance of the vehicle. In addition, increasing the thickness can substantially increase the manufacturing cost of the vehicle.

There remains, therefore, a need for a cost-effective approach to reduce passenger injuries from SOI crashes without adding any significant weight to the vehicle.

### SUMMARY

One embodiment of the present application describes a system for improving the stiffness of a hinge pillar assembly employed for attaching a front door to an automotive vehicle. The hinge pillar assembly includes an inner pillar and an outer pillar, each having cavities. These cavities can be filled with bulkheads to provide stiffness to the hinge pillar assembly. The bulkheads are adapted based on the dimensions of the cavities to ensure that the bulkheads are substantially secured in these cavities. In an implementation, the bulkheads can be adapted to be substantially secured in the cavities of the outer pillar. In another embodiment, the bulkheads, which are secured inside the hinge pillar assembly, can be attached to the front door via the hinge pillar assembly. In yet another embodiment, the bulkheads can be secured in the cavity of other vehicle parts, such as a A-pillar assembly, a B-pillar assembly, a C-pillar assembly, or the roof, rocker beams and door assemblies.

### BRIEF DESCRIPTION OF THE DRAWINGS

The figures described below set out and illustrate a number of exemplary embodiments of the disclosure. Throughout the drawings, like reference numerals refer to identical or functionally similar elements. The drawings are illustrative in nature and are not drawn to scale.

FIG. 1 illustrates a side view of an exemplary automotive vehicle frame according to one embodiment of the present subject matter.

FIG. 2A illustrates a perspective view of an exemplary hinge pillar assembly in an automotive vehicle, according to one embodiment of the present subject matter.

FIG. 2B illustrates a perspective view of an exemplary bulkhead for the hinge pillar assembly of FIG. 2A, according to one embodiment of the present subject matter.

### DETAILED DESCRIPTION

The following detailed description is written with reference to the figures. Exemplary embodiments are described to illustrate the subject matter of the disclosure and not to limit its scope, which is defined by the appended claims.

### Overview

The present disclosure describes a system for improving strength and stiffness of a hinge pillar assembly in automotive vehicles. In an embodiment, the system includes increasing the stiffness of the hinge pillar assembly employed to attach the front door to the automotive vehicle by adding bulkheads. A bulkhead is a material that fills and reinforces a cavity, and is well known in the art. The hinge pillar assembly includes an inner pillar and an outer pillar, each having cavities. In order to increase the stiffness of the hinge pillar assembly, bulkheads can be secured in the cavities of the inner pillar or the outer pillar, or both. The bulkheads are adapted to the dimensions of the cavities for substantially securing the bulkheads in the cavities. In another embodiment, the bulkheads can be secured with other vehicle parts, such as an A-pillar assembly, a B-pillar assembly and a C-pillar assembly, to provide the required stiffness and strength.

The bulkheads provide a cost-effective solution for increasing the load bearing capacity of the hinge pillar assembly, without adding any significant weight. As a result, crash worthiness of the vehicle is improved, and occupant safety is increased.

### EXEMPLARY EMBODIMENTS

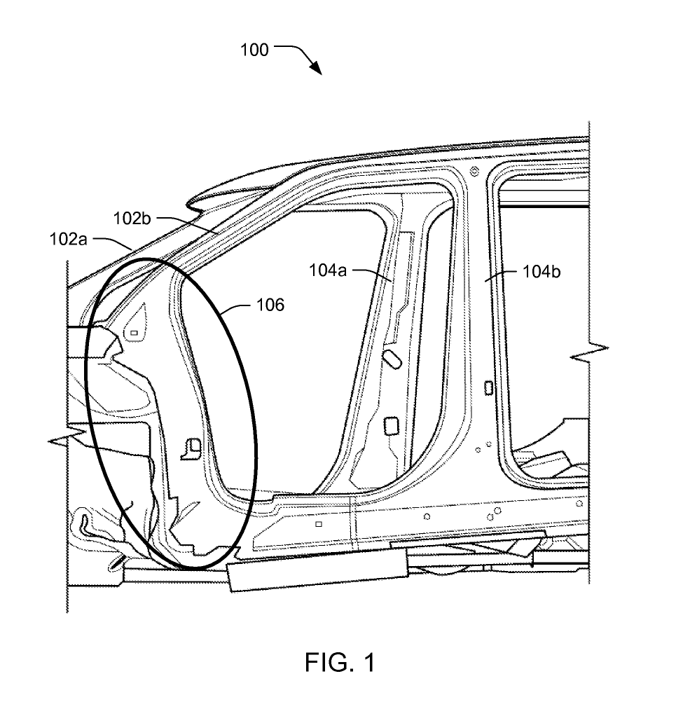

FIG. 1 illustrates a side view of an exemplary automotive vehicle frame. The automotive vehicle frame 100 includes A-pillar assemblies 102a and 102b, hereinafter collectively referred to as 102, B-pillar assemblies 104a and 104b, hereinafter collectively referred to as 104, and a hinge pillar assembly 106. The A-pillar assemblies 102, the B-pillar assemblies 104 and the hinge pillar assembly 106 are support structures mounted on the vehicle frame for attaching other vehicle parts, such as roof, doors, and windscreen, to the automotive vehicle 100. The hinge pillar assembly 106 can be integrated with the A-pillar assembly 102b and is provided as an extension of the A-pillar assembly 102b. Generally, hinge pillar assembly 106 is manufactured separately and then assembled to the A-pillar assembly 102.

The A-pillar assemblies 102 are located in the front section of the vehicle 100 and support the windscreen. The A-pillar assemblies 102 act as safety structures for occupant protection against frontal crashes. The B-pillar assemblies 104, which are located adjacent to the A-pillar assemblies 102, act as safety structures against roll-over and side impact crashes. The B-pillar assemblies 104 facilitate attachment of the rear doors to the vehicle 100. In an implementation, the hinge pillar assembly 106 is located in the front section of the vehicle 100, and is employed for attaching the front door to the vehicle body. The thickness and stiffness of the hinge pillar assembly 106 is a known measure in determining the crashworthiness of the vehicle 100 in the event of frontal crashes, such as SOI crashes.

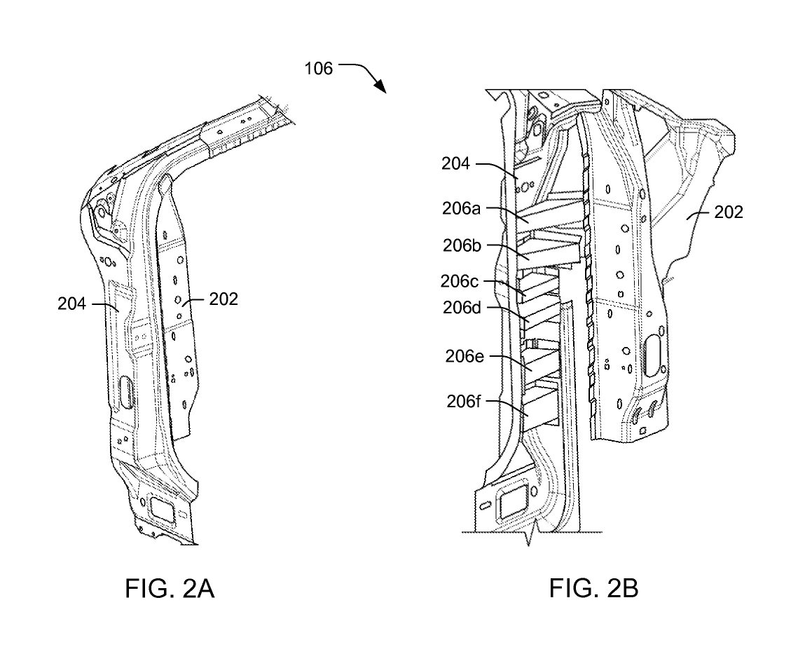

FIG. 2A illustrates a perspective view of an exemplary hinge pillar assembly in an automotive vehicle. The hinge pillar assembly 106 includes an inner pillar 202 and an outer pillar 204, which are usually manufactured separately. During assembling of the vehicle parts, the inner pillar 202 is attached to the outer pillar 204. Generally, the inner pillar 202 is welded to the outer pillar 204 to ensure a reliable attachment between the two pillars. However, it is to be understood that the inner pillar 202 can be attached to the outer pillar 204 using a variety of techniques known in the art. In an implementation, the inner pillar 202 and the outer pillar 204 have cavities such that there is a hollow separation when the two pillars are attached together to form the hinge pillar assembly 106. The hollow separation facilitates introduction of hinges employed for attaching the front door with the vehicle body. Also, in case of frontal crashes, the hollow separation can contribute in reducing the crash energy which is hazardous to the occupant compartment, and thus to the occupant safety.

FIG. 2B illustrates a perspective view of an exemplary bulkhead for the hinge pillar assembly of FIG. 2A. In an embodiment, reinforcement members such as bulkheads 206a, 206b, 206c, 206d, 206e, and 206f, hereinafter collectively referred to as 206, are secured inside the hinge pillar assembly 106. In an implementation, dimensions of the bulkheads 206 can be adapted based on dimensions of the cavities in the outer pillar 204 of the hinge pillar assembly 106 to substantially secure the bulkheads in these cavities. For example, box-shaped bulkheads 206 can be adapted to substantially secure them in the cavities of the outer pillar 204. Similarly, in another implementation, dimensions of the bulkheads 206 can be adapted to substantially secure the bulkheads 206 in the cavities of the inner pillar 202. The bulkheads 206 can be secured with the inner pillar 202 or the outer pillar 204 using a variety of mechanisms, for example, nut-bolts, welding, adhesives, etc. The bulkheads 206 can be manufactured using a range of materials such as metals, alloy metals, composites and polymeric materials. Specific examples of these materials include, but are not limited to, aluminium, tungsten, high-strength low-alloy steel, nylon, carbon-fiber-reinforced-plastic, etc.

The introduction of bulkheads 206 inside the hinge pillar assembly 106 improves the load bearing capacity and crash tolerance of the hinge pillar assembly 106 towards SOI crashes. The bulkheads 206 also significantly improve the integrity of the A-pillar assemblies 102 and the vehicle body to avoid door opening intrusion during and after the crash impact loading and reduce head as well as knee-thigh-hip (KTH) injuries. Moreover, rotation and translation of the inboard components, such as an instrument panel and a steering wheel column, located inside the occupant compartment is significantly reduced, thereby decreasing occupant injuries. Further, the bulkheads 206 provide a cost effective solution for improving the stiffness of the hinge pillar assembly 106 without addition of any significant weight to the vehicle 100.

In another embodiment, the bulkheads 206 can participate in the attachment of a vehicle part to the automotive vehicle 100. For example, the front door can be attached to the bulkheads 206 via the hinge pillar assembly 106 through hinges or any other mechanism known in the art, thus replacing the currently used door hinge reinforcements. Such attachment of the bulkheads 206 with the front door can further strengthen and improve stiffness of the hinge pillar assembly 106. In yet another embodiment, the bulkheads 206 can be secured with different parts of the automotive vehicle 100 using a variety of mechanisms known in the art to provide stiffness and strength to these parts. Examples of the parts of the vehicle body include, but are not limited to, a A-pillar assembly, a B-pillar assembly, a C-pillar assembly, roof, rocker panels, door beam, door beam assemblies, etc.

The specification has set out a number of specific exemplary embodiments, but those skilled in the art will understand that variations in these embodiments will naturally occur in the course of embodying the subject matter of the disclosure in specific implementations and environments. It will further be understood that such variation and others as well, fall within the scope of the disclosure. Neither those possible variations nor the specific examples set above are set out to limit the scope of the disclosure. Rather, the scope of claimed invention is defined solely by the claims set out below.

1. A reinforcement structure configured to be positioned along a portion of a door frame of a vehicle between a side pillar and an underbody structure of the vehicle, the structure comprising:
an outer pillar having a cavity;
a plurality of bulkheads secured within the cavity, the bulkheads being adapted to fit into the cavity; and
an inner pillar attached to the outer pillar, wherein the inner pillar encloses the one or more bulkheads.

2. The structure of claim 1, wherein the bulkheads are secured to the cavity by one of welding, soldering and adhesively bonding the bulkheads to the cavity.

3. The structure of claim 1, being a hinge pillar assembly for the vehicle.

4. The structure of claim 1, wherein the inner pillar is welded to the outer pillar.

5. A hinge pillar assembly for a vehicle, the hinge pillar assembly being attached to a portion of a door frame of the vehicle, and having at least one cavity, wherein a plurality of bulkheads are secured within the cavity, the bulkheads being configured to provide reinforcement to the structure of the hinge pillar assembly.

6. The hinge pillar assembly of claim 5, wherein the bulkheads are secured within the cavity by one of welding, soldering, brazing or adhesive bonding.

7. An automotive vehicle comprising:
a hinge pillar assembly positioned along a portion of a door frame of the vehicle between a side-pillar and an underbody structure of the vehicle, the hinge pillar assembly having at least one cavity;
a plurality of bulkheads positioned within the cavity, the bulkheads being configured to provide reinforcement to the structure of the hinge pillar assembly.

8. The automotive vehicle of claim 7, wherein the bulkheads are secured within the cavity by one of welding, soldering or adhesively bonding the bulkheads to the cavity.

9. (canceled)

10. The hinge pillar assembly of claim 5, further comprising an inner pillar and an outer pillar attached to the inner pillar, wherein both the inner pillar and the outer pillar have a hollow interior portion defining cavities therein, and the plurality of bulkheads are positioned and secured within the cavity of the inner pillar or the outer pillar.

11. The hinge pillar assembly of claim 5, wherein the shape and size of the bulkheads depends on the surface profile of the cavities defined within the inner pillar and the outer pillar.

12. The automotive vehicle of claim 7, wherein the hinge pillar assembly includes an inner pillar and an outer pillar, and the at least one cavity is provided within at least one of the inner pillar and the outer pillar, and plurality of bulkheads are positioned and secured within the at least one cavity.

13. The automotive vehicle of claim 12, wherein the shape, size and structure of the bulkheads depends on the surface profile of the cavity.

14. The reinforcement structure of claim 1, wherein the side-pillar is one of a group consisting of an A-pillar, a B-pillar, a C-pillar, and a D-pillar of the vehicle.

15. The hinge pillar assembly of claim 5, wherein the portion of the door frame of the vehicle lays between a side-pillar and an underbody structure of the vehicle, the side-pillar being one of a group consisting of an A-pillar, a B-pillar, a C-pillar, and a D-pillar of the vehicle.

16. The automotive vehicle of claim 7, wherein the side-pillar is one of a group consisting of an A-pillar, a B-pillar, a C-pillar, and a D-pillar of the vehicle.
